(19) United States
(12) Patent Application Publication
(10) Pub. No.: US 2005/0256929 A1
(43) Pub. Date: Nov. 17, 2005

(54) Systems and methods for enhancing the screening of electronic message data

(76) Inventors: Christopher Bartol, Evanston, IL (US); Elizabeth Ferguson, Evanston, IL (US); Jeffrey Mills, Naperville, IL (US); Frank Nitsche, Sugar Grove, IL (US)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/821,529

(22) Filed: Apr. 9, 2004

(51) Int. Cl. G06F 15/16

(52) U.S. Cl. 709/206

(57) ABSTRACT

The present invention relates generally to the field of automated screening systems that assist in screening the content of message data prior to public posting of the messages. More specifically, the present invention is directed to systems and methods for enhancing the screening of messages that are posted to on-line guest books and message boards associated with on-line obituaries and the like in order to substantially reduce and/or eliminate the posting of messages with inappropriate or undesirable content.

### BACKGROUND OF THE INVENTION

1. Field of the Invention

The present invention relates generally to the field of automated screening systems that assist in screening the content of message data prior to public posting of the messages. More specifically, the present invention is directed to systems and methods for enhancing the screening of messages that are posted to on-line guest books and message boards associated with on-line obituaries and the like in order to substantially reduce and/or eliminate the posting of messages with inappropriate or undesirable content.

2. Description of the Related Art

Historically, obituaries or death notices have been published regularly in print publications such as newspapers and the like for many years. More recently, obituaries and death notices have been published through Internet accessible websites that are typically associated with individual newspapers, funeral homes, and synagogues or churches. One of the features of these existing electronic publishing systems is the ability to provide a so-called guest book wherein users can express their condolences or otherwise pay tribute to the deceased with messages and other stories.

The guest books are generally available to the public in that anyone may access and read them, or add an entry to the online guest book or obituary. Currently, approximately 1 of every 3 people who die each day in the United States has an online guest book. There has recently been a dramatic growth in utilization of this service, which until recently, was entirely nonexistent. Currently more than 200,000 people leave entries every month in established online guest books.

The general intention of the online guest book is to provide friends and relatives, or even strangers, with the ability to share thoughts, feelings, and otherwise publicly display information concerning the deceased. The guest books can be a tremendous source of comfort for families and friends and aid in the grieving process. For the most part, these electronic guest books have been very well-received and provide a very positive source of reassurance during a very difficult time.

In order to facilitate the use of the systems, it is necessary to provide a convenient means of providing users with the ability to freely and easily access the message posting system. This access is typically provided via the Internet. The conventional systems for posting the expressions of individuals to the guest book requires that virtually anyone be able to access and post information or a message. One of the unfortunate problems associated with the ability to conveniently access the posting system is that individuals have been taking advantage of the system by posting messages with inappropriate or undesirable content. Surprisingly, there are a number of individuals who will intentionally post hurtful or derogatory messages, and may slander the deceased's name, even market a product or promote a particular cause. Because of the nature of the system, it has become necessary to ensure that only appropriate content is publicly displayed in the guest books through the use of a review process.

In order to achieve the important goal of ensuring that only appropriate messages are posted, the conventional online guest book services utilized a manual review process in which each and every single entry or posting was submitted for publication to an electronic queue where it remained prior to publication until it was reviewed by an editor. After the appropriate review process, the data was posted in the desired guest book. This manual review process was a highly effective technique which could be used to ensure that only appropriate message content is posted. However, due to the continued dramatic increase in the utilization of the online obituary message posting services, there remains a need in the art for improving the speed with which the individual messages can be reviewed prior to publication.

Furthermore, it has also been recognized that any system for improving the efficiency and speed with which the messages are cleared for posting or publication, must be flexible and capable of handling a wide range of undesirable content. For example, one posting in particular exemplifies the problems encountered in providing free and convenient public access to the obituary posting services. The message concerned a recently deceased woman and went so far as to discuss the deceased's participation in the Wannsee Conference many years ago. On its face, the proposed posting generally appeared innocuous as to the deceased's participation in the conference and indeed most individuals would not even recognize this reference as being inappropriate and offensive content.

However, the Wannsee Conference was actually a meeting held at a villa in the Wannsee community of Berlin, Germany on Jan. 20, 1942 at which Nazi leaders discussed the implementation of Hitler's final solution, including the various methods they would use to exterminate the Jewish population. This guest book entry was that of a recently deceased Jewish woman making the entry all the more hurtful. Fortunately, the inappropriate nature of the message was noticed shortly after initial publication and it was then promptly removed.

This event, and other similar attempts to place inappropriate content in the online guest books has increased the need for an improved system to monitor the proposed postings for online guest books and other messages concerning deceased individuals. In light of the continuing growth in the utilization of this service, it has become increasingly difficult to provide high-quality manual review of each and every message prior to posting. The inability to provide a more automated comprehensive solution would ultimately result in a decrease in growth of the online obituary business and ultimately the decline of this valuable service.

Accordingly, there remains a need in the art for new and improved systems and methods for enhancing the screening of proposed postings for online guest books and message boards associated with on-line obituaries, and the like. One object and advantage of the present invention is to provide systems and methods that increase the effectiveness while enhancing the productivity of the automated screening process. Another object of the present invention is to ensure that an extremely high degree of quality review is provided for each of the message postings. Other objects and advantages will be apparent in light of the following Summary and Detailed Description of the Presently Preferred Embodiments.

### SUMMARY OF THE INVENTION

The present invention is generally directed to systems and methods for enhancing the review process and increasing the automated processing of proposed messages and content for online obituaries and death notices. In accordance with the present invention, the entire content of all messages is searched and reviewed in order to identify the presence of one or more words and/or phrases from among thousands of words and phrases whose entry into the guest book suggests a message with content that may be inappropriate.

The individual words that have been identified as being inappropriate or otherwise indicating inappropriate content are loaded into a database which contain terms that are used in screening the proposed postings. If a proposed posting includes one of the identified inappropriate words or phrases, the posting is then automatically flagged and sent to a queue for review by a highly experienced individual for review. Over time, the list of words and phrases that are designated as being inappropriate is updated.

Although it is possible to entirely eliminate the manual review of any messages that have been cleared by the initial screening process that automatically identifies the presence of certain words and/or phrases that indicate inappropriate content, in accordance with the preferred exemplary embodiment, all messages are manually reviewed in order to ensure that the highest degree of quality is maintained. In accordance with the preferred exemplary embodiment, those messages which have been identified as containing potentially inappropriate words and/or phrases are reviewed by more experienced content editors. Those messages that do not contain any of the designated words and phrases are reviewed by other less experienced individuals. This ensures that the review process resources are appropriately allocated.

Another portion of the screening process is directed to the name of the deceased individuals. This screening process provides the ability to screen names of decedents so that any guest book entries submitted into that particular guest book is automatically flagged for closer scrutiny. This is particularly helpful because celebrities or other well-known individuals tend to attract a higher volume of inappropriate entries.

Yet another aspect of the screening process is used to block specific IP addresses or computer locations from which inappropriate proposed entries have been placed, in order to automatically flag future entries from this user or IP address so they can be more closely scrutinized. In accordance with this alternate preferred exemplary embodiment of the system, whenever messages which contain inappropriate words and/or phrases are identified, the IP address from which the message originated is maintained so that any additional messages received from this particular IP address may be more closely scrutinized by the more experienced content editors. In the preferred embodiment, the messages are not automatically blocked but if a significant number of inappropriate messages originate from a particular IP address, subsequent proposed postings may be automatically blocked. Additionally, whenever an undesirable message is received from a particular address, a message may be sent to that address in order to inform the individual transmitting the inappropriate content that additional steps will be taken to ensure that no further similar messages will be transmitted.

### BRIEF DESCRIPTION OF THE DRAWINGS

FIG. 1 illustrates a first exemplary embodiment of the present invention; and

FIG. 2 illustrates an alternate exemplary embodiment of the present invention.

### DETAILED DESCRIPTION OF THE PRESENTLY PREFERRED EMBODIMENTS

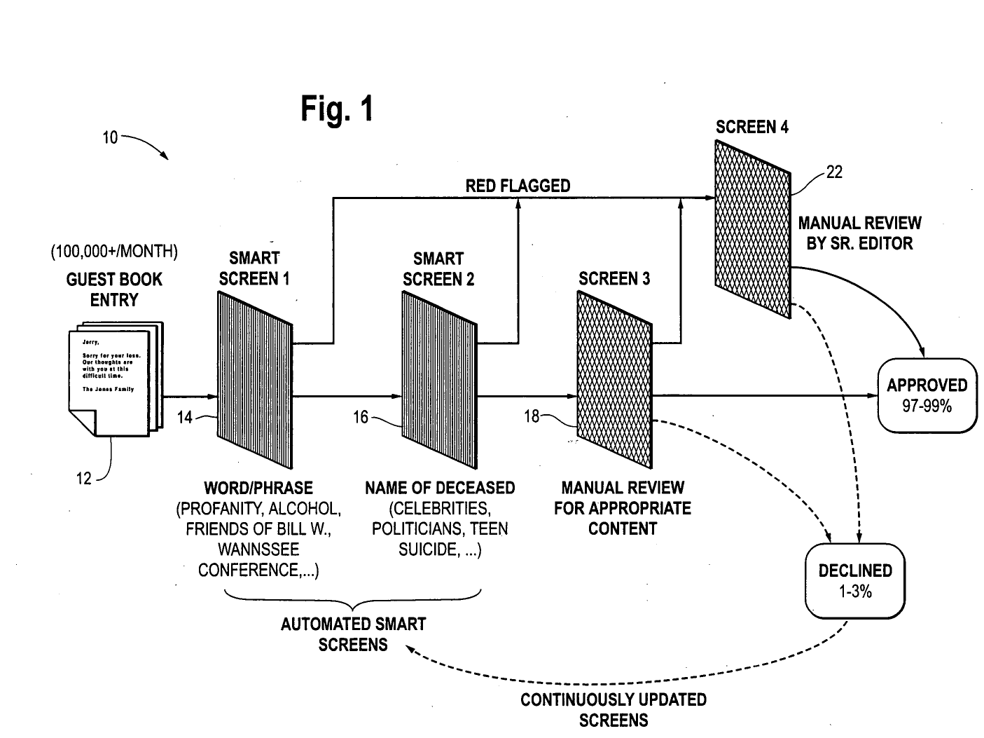

FIG. 1 illustrates a first exemplary embodiment of the present invention which is shown generally at 10. Although FIG. 1 illustrates a preferred exemplary embodiment having a specified flow for the processing of proposed messages for posting, those skilled in the art will appreciate that other alternate processing flows may be utilized and nonetheless fall within the spirit and scope of the present invention.

As illustrated in FIG. 1, initially the proposed guest book entry or message is received preferably via a Web interface. More specifically, each of the entries 12 is received via a web site and is preferably deposited onto a web server or other electronic memory which is accessible via the Internet that has not been shown for the sake of convenience. A first screening process is applied to each of the user-submitted guest book entries 12 in a first processing stage 14. In this first processing stage 14, various inappropriate words and preferably phrases as well are maintained in a database or other data construct and the words and phrases of the proposed message are compared with the words and phrases of the database or other data construct to ensure that all of the content within the proposed message is appropriate. This initial screening process 14 is preferably performed by a computer that has access to the proposed guest entries as well as the database or listing of inappropriate words, phrases or words and phrases.

It should be recognized that the initial screening which compares preferably both words and phrases from a database or other data construct may also be modified to screen messages for only words or only phrases that are designated as inappropriate during the initial screening process 14. More specifically, it is only preferred that both inappropriate words and phrases are both maintained in a database for comparison with the content of the proposed messages. However, alternate versions of the system may only screen for words or phrases independently.

It should also be recognized that the specified database containing inappropriate words and/or phrases maybe replaced by a simple list or file containing the identified inappropriate words and phrases. Those skilled in the art will recognize that virtually any data construct which maintains the words, phrases or phrases and words may be utilized for the purpose of the initial automated screening of the messages 14.

As illustrated in FIG. 1, proposed messages which are flagged as containing inappropriate words and/or phrases are identified and proceed to further manual screening preferably by a more highly skilled editor or content reviewer in a final manual screening process 22. Alternatively, if no inappropriate content is identified during the initial automated processing, the message is subsequently further automatically reviewed in order to determine whether the name of the deceased individual has been designated as being particularly notorious or has otherwise been designated as being more likely to receive inappropriate messages. For example, experience has indicated that celebrities, politicians and teen suicides are more likely to receive inappropriate messages and therefore postings for these individual should be more closely scrutinized.

In this second screening process 16, the name of the deceased is cross-referenced with a database of individuals who are particularly notorious or otherwise likely to receive inappropriate messages as noted above. Those messages that are flagged as a result of a match between the name of the individual and a list or database containing names which are likely to receive inappropriate messages are identified and proceed to further manual screening preferably by a more highly skilled editor or content reviewer in a final manual screening process 22. Alternatively, if no inappropriate content is identified during the initial automated processing, the message is subsequently manually reviewed by any available editor in order to perform a personal review to determine whether any inappropriate content is contained within the message. This is performed during a manual screening step at 18.

Even in situations where neither the automated processing of steps 14 and 16 nor the manual review of step 18 have identified any inappropriate message content, the message is also preferably subjected to a final high quality review by an experienced content editor in step 22. However, those skilled in the art will appreciate that it is not necessary to perform multiple manual reviews by separate individuals. In an alternate preferred exemplary embodiment, the manual review process is performed only once and the initial automatic screening information concerning messages that contain inappropriate content is merely used as an aid in identifying those messages that are more likely to contain inappropriate content. Regardless of the embodiment, when the prescreening processing identifies potentially undesirable content, the message is designated as such. For example, the identified words or phrases are highlighted, underlined or otherwise visually set off from the remaining text of the message so that the subsequent manually screening may more readily determine the nature of the content. Alternatively, the message is simply designated as falling into a high probability category for containing inappropriate content.

Those skilled in the art will appreciate that the second automated screening process 16 can easily be incorporated into the first screening process 14 so that only a single automated screening is performed in order to identify those messages that should receive closer scrutiny. For example, in this embodiment a single table or list is provided which also contains the names of the high-risk deceased individuals. The second screening process 16 is preferably automatically performed by the same computer system that performs the initial screening process 14. However, it is recognized that an alternate computer or processor may be utilized and also accomplish the same results.

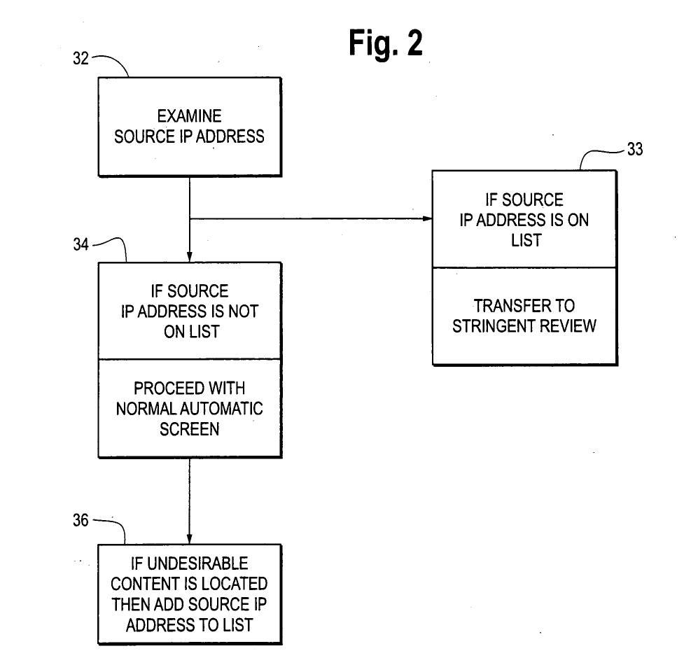

FIG. 2 illustrates yet another aspect of the screening process which is used to block specific IP addresses or computer locations from which inappropriate proposed entries have been placed, in order to automatically flag future entries from this user or IP address so they can be more closely scrutinized. In accordance with this alternate preferred exemplary embodiment of the system, when a message is initially received, the source IP address is compared with a list, table or database of source IP addresses from which messages containing inappropriate content previously originated. This occurs in a first step 32.

If the source IP address is an IP address that is associated with a message that was previously determined to be inappropriate then the message is flagged for processing during a more highly skilled manual review. This occurs in step 33. The subsequent highly skilled manual screening may occur without any of the other automated screening processing described above. Alternatively, if the IP address is not associated with previously transmitted messages containing inappropriate content, the message is further processed utilizing the automated techniques described above in order to automatically identify the presence of any inappropriate messages. The normal automatic processing occurs in step 34.

Whenever messages which contain inappropriate words and/or phrases are identified, the IP address from which the message originated is maintained so that any additional messages received from this particular IP address may be more closely scrutinized by the more experienced content editors. This occurs in step 36 wherein after further processing, when inappropriate content is confirmed, the source address is added to the list or table of inappropriate addresses for subsequent message screening.

In the preferred embodiment, the messages are not automatically blocked from a designated IP address, but if a significant number of inappropriate messages originate from a particular IP address, subsequent proposed postings may be automatically blocked. Additionally, whenever an undesirable message is received from a particular address, a message may be sent to that address in order to inform the individual transmitting the inappropriate content that additional steps will be taken to ensure that no further similar messages will be transmitted.

The present invention has been described with reference to preferred exemplary embodiments and those skilled in the art will appreciate that various modifications may be made to the systems of the present invention but that will nonetheless fall within the spirit and scope of the appended claims.

1. A system for reviewing a message content comprising:
a storage containing at least one message for review;
a memory containing a plurality of words whose presence in a message indicates that the message is at least likely to be inappropriate;
a computer processor for comparing words in the message to be screened with words in the memory in order to identify messages which are at least likely to contain inappropriate content; and
a means for designating a message as containing or being likely to contain inappropriate content.

2. The system for reviewing a message content of claim 1, further comprising a means for transmitting the message to a terminal for manual review.

3. The system for reviewing a message content of claim 1, further comprising a web interface for receiving messages to be reviewed.

4. The system for reviewing a message content of claim 1, further comprising a means for comparing a source IP address with a list of IP addresses from which messages containing inappropriate content have been previously received.

5. The system for reviewing a message content of claim 1, further comprising a means for comparing phrases in the message to be screened with phrases in the memory in order to identify messages which are at least likely to contain inappropriate content.

6. The system for reviewing a message content of claim 1, further comprising a means for comparing a name in the message to be screened with words in the memory in order to identify messages which are at least likely to contain inappropriate content.

7. The system for reviewing a message content of claim 6, further comprising a means for transmitting the message to a terminal for manual review.

8. The system for reviewing a message content of claim 6, further comprising a means for transmitting the message to a second terminal for detailed manual review.

9. A method for reviewing message content comprising:
storing at least one message for review;
storing in a memory a plurality of words whose presence in a message indicates that the message is at least likely to be inappropriate;
comparing words in the message to be screened with words in the memory in order to identify messages which are at least likely to contain inappropriate content; and
designating a message as containing or being likely to contain inappropriate content.

10. The method for reviewing a message content of claim 9, further comprising a means for transmitting the message to a terminal for manual review.

11. The method for reviewing message content of claim 9, further comprising a step of receiving messages to be reviewed via a web interface.

12. The method for reviewing a message content of claim 9, further comprising comparing a source IP address with a list of IP addresses from which messages containing inappropriate content have been previously received.

13. The method for reviewing message content of claim 9, further comprising comparing phrases in the message to be screened with phrases in the memory in order to identify messages which are at least likely to contain inappropriate content.

14. The method for reviewing message content of claim 9, further comprising comparing a name in the message to be screened with words in the memory in order to identify messages which are at least likely to contain inappropriate content.

15. The method for reviewing a message content of claim 14, further comprising transmitting the message to a terminal for manual review.

16. The method for reviewing message content of claim 15, further comprising transmitting the message to a second terminal for detailed manual review.
